(19) United States
(12) Patent Application Publication
(10) Pub. No.: US 2025/0166060 A1
(43) Pub. Date: May 22, 2025

(54) GENERATIVE ARTIFICIAL INTELLIGENCE (AI) CONTEXTUAL CREDIT METERING

(71) Applicant: Salesforce, Inc., San Francisco, CA (US)

(72) Inventors: Oleksandr Minaiev, Munster, IN (US); Fermin Ordaz, San Francisco, CA (US); Khoa Le, San Francisco, CA (US); Na Cheng, Yarrow Point, WA (US)

(73) Assignee: Salesforce, Inc., San Francisco, CA (US)

(21) Appl. No.: 18/514,287

(22) Filed: Nov. 20, 2023

(51) Int. Cl. G06Q 40/03

(52) U.S. Cl. CPC G06Q 40/03

(57) ABSTRACT

In some embodiments, a method stores a total number of generative credits for a generative artificial intelligence (AI) solution that is integrated with a software application in a database system. Usage data is tracked for a request to the generative artificial intelligence (AI) solution in the database system. The method determines a context from the usage data and retrieves a contextual pricing model for the generative AI solution using the context. The contextual pricing model translates a model specific charging policy to generative credits. The method applies the usage data to the contextual pricing model to translate the usage data to a number of generative credits. The number of generative credits for the generative AI solution is applied to an available number of generative credits of the total number of generative credits to generate a new available number of generative credits.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### FIELD OF TECHNOLOGY

This patent document relates generally to database systems and more specifically to generative artificial intelligence systems.

### BACKGROUND

“Cloud computing” solutions provide shared resources, applications, and information to computers and other devices upon request. In cloud computing environments, services can be provided by one or more servers accessible over the Internet rather than installing software locally on in-house computer systems. Users can interact with cloud computing solutions to undertake a wide range of tasks. The services may be charged to consumers. For example, a consumer may be offered access based on a per user license. The consumer would then be charged based on the number of users of the software application.

The use of generative artificial intelligence (AI) solutions may be integrated into the cloud computing system. However, the use of generative AI solutions may be different than the traditional usage of software applications in the cloud computing system. Accordingly, it may be difficult to integrate the generative AI solutions into the structure of the cloud computing system.

### BRIEF DESCRIPTION OF THE DRAWINGS

The included drawings are for illustrative purposes and serve only to provide examples of possible structures and operations for the disclosed inventive systems, apparatus, methods and computer program products for generative AI systems. These drawings in no way limit any changes in form and detail that may be made by one skilled in the art without departing from the spirit and scope of the disclosed implementations.

FIG. 1 depicts a simplified system for providing generative AI solutions according to some embodiments.

FIG. 2 depicts a more detailed example of a database system according to some embodiments.

FIG. 3 depicts an example of managing SKUs according to some embodiments.

FIG. 4 depicts an example of provisioning the entitlements and licenses for the SKUs according to some embodiments.

FIG. 5 shows a block diagram of an example of an environment that includes an on-demand database service configured in accordance with some implementations.

FIG. 6A shows a system diagram of an example of architectural components of an on-demand database service environment, configured in accordance with some implementations.

FIG. 6B shows a system diagram further illustrating an example of architectural components of an on-demand database service environment, in accordance with some implementations.

FIG. 7 illustrates one example of a computing device.

### DETAILED DESCRIPTION

### System Overview

A system may integrate generative artificial intelligence (AI) solutions into a cloud computing system. The generative AI solutions may use a large language model (LLM) to generate responses to requests. For example, a consumer may be using a software application, such as a CRM application, in a cloud computing system to work on a lead for work. The CRM application may have an integrated generative AI solution, such as the generative AI solution may be included in a window of the CRM application, or be accessible while using the CRM application. The consumer may send a request of “How many employees does company X have?” to the generative AI solution. The generative AI solution may answer the request with a response of “The company X includes 10,000 employees.” The response may then be displayed in the CRM application.

As discussed above, the cloud computing system may offer other solutions, such as software applications including customer relation management (CRM) applications. The use of the generative AI solutions may be different compared to the use of other software applications. For example, a service provider of the cloud computing system may charge for the other software applications on a per user basis, such as the use of the CRM application may be charged based on how many licenses for users are needed. However, the generative AI solutions may be charged based on a per use basis of the generative AI solution. For example, a generative AI solution may charge based on the number of tokens in a request (e.g., the number of words in the request), or the number of words in a response. The generative AI solutions may also include multiple different solutions, which may use different large language models. The different generative AI solutions may have different methodologies for charging, such as per request, a number of tokens in a request, or other methods.

In some embodiments, a system integrates the generative AI solutions into the cloud computing system. The system tracks the use of generative AI solutions. Then, the system uses a contextual pricing model to determine how to charge for the use of the different generative AI solutions. The contextual pricing model may be based on how a respective generative AI solution charges for using its service. In some embodiments, the system may convert the usage for different generative AI solutions into a number of credits that are used based on the contextual pricing model. The contextual pricing model may allow generative AI solutions to charge differently, but the use is converted into a unified cost structure for the cloud computing system. Then, a service provider can charge companies based on the number of credits used. This provides a unified billing solution for generative AI solutions and the cloud computing system.

### System

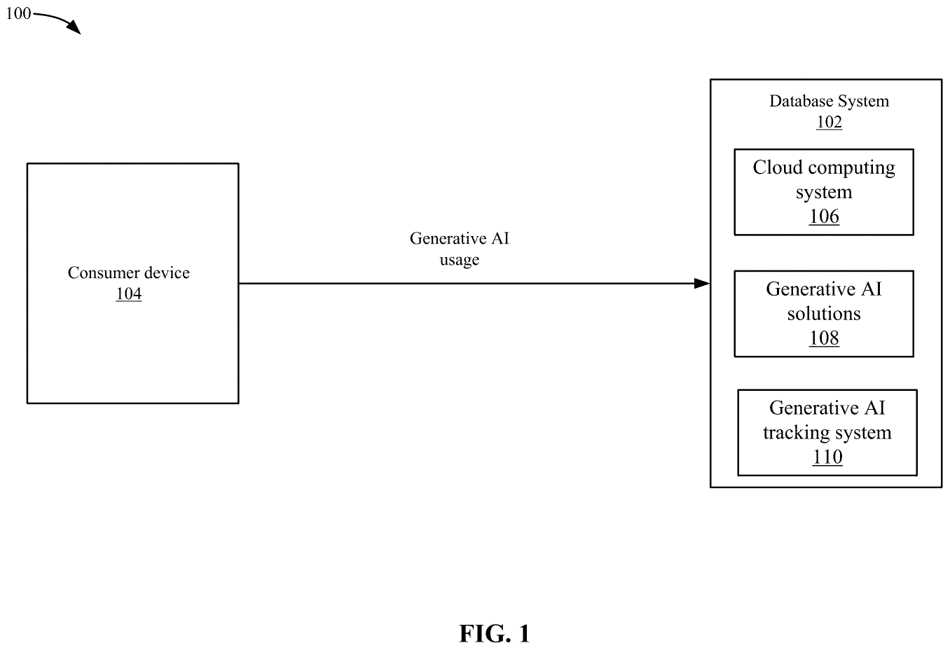

FIG. 1 depicts a simplified system 100 for providing generative AI solutions according to some embodiments. System 100 includes a database system 102 and a consumer device 104. Although single instances of database system 102 and consumer device 104 are shown, multiple instances of each may be provided. Details of database system 102 will be described in more detail below. For example, database system 102 may be a multi-tenant database system.

Database system 102 includes a cloud computing system 106, generative AI models 108, and a generative AI tracking system 110. Cloud computing system 106 may include different cloud-based solutions, such as software applications. Consumer device 104 may access various software applications using cloud computing systems 106.

Generative AI solutions 108 may be different generative AI solutions that may use different generative AI models. For example, different large language models may be used to determine responses to requests. Also, different generative AI solutions 108 may charge for processing requests and providing responses differently. Further, generative AI solutions 108 may be internal or external solutions. For example, a service provider that provides cloud computing system 106 may have its generative AI solution. Also, external companies may provide generative AI solutions that the service provider uses.

Generative AI tracking system 110 may track the usage of generative AI solutions 108. For example, generative AI tracking system 110 may track the usage of generative AI solutions 108 that are used via cloud computing system 106. Generative AI tracking system 110 may retrieve a contextual pricing model for the usage based on different characteristics of the usage, such as the generative AI solution 108 that was used, an organization that used the generative AI solution 108, and other characteristics. Then, generative AI tracking system 110 may transform the usage using the contextual pricing model to a unified model. For example, generative AI tracking system 110 may use a specific generative charging model from the contextual pricing model to transform the usage to a credit-based model. Then, generative AI tracking system 110 can output the consumption of credits per organization for the use of different generative AI solutions 108. The use of the credits allows the generative AI solutions 108 to be integrated with other software applications being used on cloud computing system 106 while providing a unified charging model for the use of them. If each individual charging model is used, then the resources that are used to keep track of the charges may be increased as different charges may be invoiced to a customer. Using the unified charging model of credits, the logic of database system 102 is simplified and a number of credits is stored for customers and the usage of the credits may be tracked.

The use of the credit system provides many advantages. For example, different charging models for different generative AI solutions 108 may be integrated together into a unified billing system. Also, the contextual pricing models may allow different generative AI solutions 108 to provide different charging models, which may be converted into a unified model, such as the credits that are used. This improves the database system 102 by allowing the integration of generative AI solutions 108 into different software applications that have charging models (e.g., per user licenses). Also, the scalability of database system 102 is improved by allowing different generative AI solutions 108 to be added by adding different contextual pricing models. A contextual pricing model for the respective generative AI solutions 108 may be added, which is then used to convert the usage of respective generative AI solutions to credits used. The contextual pricing model improves the performance of database system 102 by processing transactions more efficiently because generative AI usage may be converted in real-time to the credit based usage. This may be used to provide a report to customers or allow the service provider to accurately track the usage to make sure credit limits are not violated. Also, memory use may be saved as credit usage may be stored more efficiently compared to the generative AI requests. The data storage improvement may involve data compression, data deduplication, capturing metadata or other techniques to minimize memory usage compared to storing generative AI requests directly. Generative AI tracking system 110 may implement advanced transaction processing techniques to convert generative AI usage to credits in real-time more efficiently. This may include multi-threading, parallel processing, or hardware acceleration to speed up transaction processing.

The generative AI solutions 108 may be incorporated into the service provider's quoting, sales pipeline, and billing systems. The quoting, sales pipeline, and billing systems may be used by the service provider to offer generative AI solutions 108 to its customers. The use of the credit system introduces an efficient provisioning mechanism that automates the allocation of generative AI credits based on specific SKUs. The SKUs may be associated with services that are offered to customers of the service provider. Generative AI tracking system 110 empowers customers by displaying their real-time usage relative to entitlements, fostering transparency and informed decision-making. Generative AI tracking system 110 extends to SKU management, allowing for the incorporation of credit pools into cloud computing system SKUs and the creation of consumption-based SKUs for generative AI solutions 108, promoting adaptability across diverse cloud generative AI solutions while maintaining a centralized billing solution. Accurate tracking of generative AI consumption ensures precision in billing and resource allocation. The granular insight into feature-specific consumption supports cost optimization and tailored pricing strategies, ultimately enhancing tracing of generative AI usage and the customer experience. Generative AI tracking system 110 enhances sales efficiency, while its scalability and adaptability cater to evolving market needs, positioning it as a transformative solution at the nexus of AI, sales, and billing systems.

The following will discuss generative AI tracking system 110 in more detail followed by SKU management.

### Generative AI Tracking System

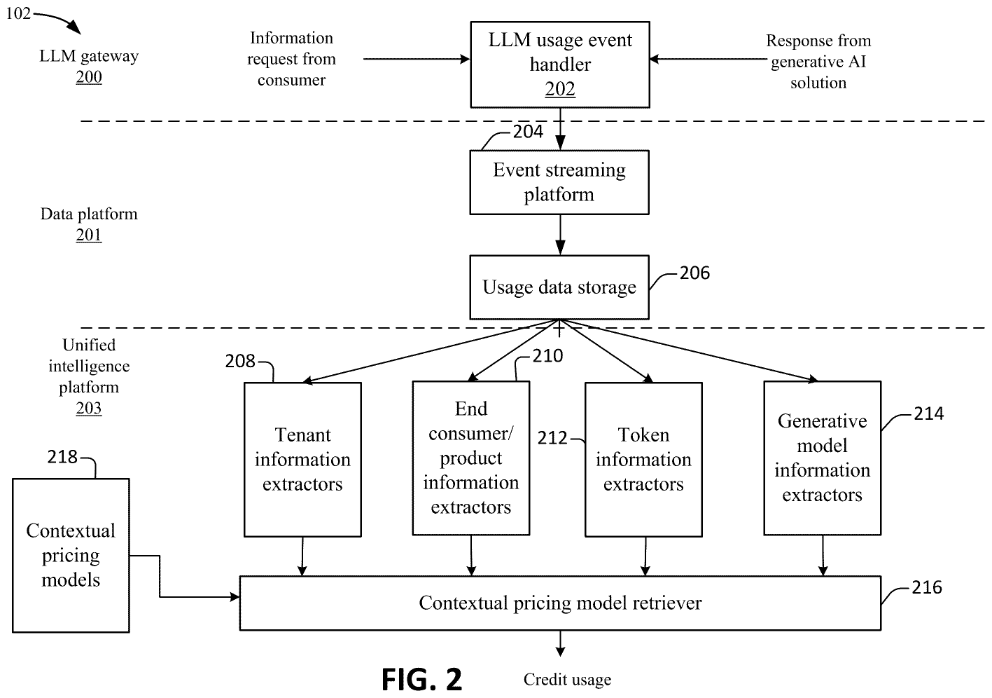

FIG. 2 depicts a more detailed example of database system 102 according to some embodiments. Generative AI tracking system 110 includes a large language model (LLM) gateway 200, a data platform 201, and a unified intelligence platform 203.

LLM Gateway 200 includes a LLM usage event handler 202 that may process requests from consumer devices 104. For example, a consumer device 104 may be using a CRM application on cloud computing system 106 that may have a generative AI solution 108. While using the CRM application, consumer device 104 sends a request of “How many employees does company X have?” to a generative AI solution 108. The request may or may not specify a generative AI solution 108 to use. Then, LLM usage event handler 202 may send the request to the requested generative AI solution 108. In other examples, LLM usage event handler 202 may select one or more generative AI solutions 108 to use if a specific generative AI solution 108 was not requested. Then, LLM usage event handler 202 may receive the response from generative AI solution 108, and provide the response back to consumer device 104.

Generative AI tracking system 110 may use a set of attributes to track usage through database system 102. The attributes allow the tracking of usage of generative AI solutions 108 and the computation of credit usage through different systems of database system 102. In some embodiments, the attributes may include a cloud cost identifier that may identify the calling cloud cost center, such as sales, service, commerce. An application type attribute may identify the application that is being used, such as a sales email assistant, generative AI application, CRM application, etc. A client feature that may identify the customer in which the request was sent. A tenant identifier which may identify the organization identifier from the customer. An AI platform tenant identifier may identify the AI platform tenant of generative AI solutions 108. A caller service attribute may identify the generative AI solution that was used. Other attributes may also be appreciated.

An event streaming platform 204 may receive usage events from LLM usage event handler 202. Event streaming platform 204 may store usage data in usage data storage 206. For example, the usage data may be stored with values for the attributes associated with the request.

Unified intelligence platform 203 may use the usage data from usage data storage 206 to calculate credit usage for customers. Unified intelligence platform 203 may use different extractors to extract information for usage of generative AI solutions 108. Then, unified intelligence platform 203 may determine a context for the usage. The context may be used to determine a contextual pricing model 218 to use to calculate the credit usage. Also, extracted information may be used to track the usage of generative AI solutions 108 for customers, such as to provide a granular breakdown of which generative AI solutions 108 were used, which organization used the generative AI solution 108, etc.

Tenant information extractors 208 may extract information about the tenant organization that used the generative AI solution 108. For example, the tenant ID attribute may be extracted from the usage data.

End consumer/product information extractors 210 may determine the consumer of the generative AI solution 108. The consumer may be based on the client feature attribute, cloud cost identifier attribute, application type attribute, or other information.

Token information extractors 212 may extract information about the tokens used in the information request. For example, the tokens may be the number of words that are used in the request. In some examples, the request “How many employees does company X have?” may have seven tokens for the seven words in the request. Also, token information extractors 212 may extract the number of tokens in the response. Token information extractors 212 may extract other information that is needed to apply the usage to the contextual pricing model, such as a number of requests if the number of requests is used to determine the amount of generative credits that is used.

Generative model information extractors 214 may extract the generative model solution 108 that was used. For example, the AI platform service type attribute may be used to determine the generative AI solution 108. Also, the provider of the generative AI solution 108 may be extracted from a provider attribute. The model name of the large language model may be extracted from a model name attribute. The duration that it takes to respond to the request may be extracted. A unique identifier for the generative process may identify the request.

A contextual pricing model retriever 216 may retrieve a contextual pricing model based on a context that was extracted. For example, different contexts may be associated with different contextual pricing models. In some embodiments, generative AI solutions 108 may have a respective contextual pricing models. Also, different organizations may also have different contextual pricing models for different generative AI solutions 108. In some embodiments, contextual pricing model retriever 216 may generate a query using the context to retrieve a contextual pricing model 218. For example, a first context may retrieve a first contextual pricing model #1 and a second context may retrieve a contextual pricing model #2. In some embodiments, the first context may be associated with a request that used a generative AI solution #1 and the second context may be associated with a request that used a generative AI solution #2. In some embodiments, the context uses a combination of dimension values from the extracted information to retrieve a contextual pricing model. For example, the dimensions of tenant ID and generative AI solution ID may be used to retrieve a contextual pricing model.

In some embodiments, generative AI solutions 108 may be charged based on a number of tokens that is used in a request. A contextual pricing model may use the following to calculate credits: generative credit=total_token_count*0.001*0.95. This contextual pricing model specifies that for every 1,000 tokens that are used for this model, 0.95 generative credits are consumed. It is based on the contextual pricing multiplier of 0.001 that charges 0.95 credits for every 1000 tokens. Other pricing models may be appreciated. For example, a pricing may be based on data volume. Extracted information about the volume of data processed by a generative AI solution 108 can be used to create pricing models. For instance, customers who generate larger amounts of text or images may be charged based on the volume of data processed. A pricing model may be based on frequency of usage. Usage data can reveal how often customers utilize a generative AI solution 108. Pricing models may offer different rates or discounts for users with high or low frequency of usage. Different generative AI solutions 108 may have varying complexities and capabilities. Extracted information about the specific model chosen by the customer can be used to determine pricing. More advanced models could be priced differently than basic ones. If customers create custom generative AI solutions 108, information about the model's architecture and features can be used to set pricing, potentially charging a premium for customization. Information about the computational resources allocated for generating content, such as GPU or CPU usage, can impact pricing. Users consuming more resources may be charged more. If the generative AI solution 108 offers parallel processing for faster generation, pricing models can take into account the number of parallel processes initiated by the customer. Extracted information on data transfer, such as the amount of data transferred in and out of the generative AI solution 108, can influence pricing. Users with higher data transfer requirements may pay more. If the generative AI solution 108 provides data storage for generated content, pricing models may factor in the amount of storage used by each customer. Information about the service level agreements, including guaranteed response times and availability, can impact pricing. Premium SLAs may come at a higher cost. Different user roles within an organization may require different pricing structures. Extracted user profile information can be used to apply role-specific pricing. Enterprise vs. Individual: Customers from different types of organizations (e.g., enterprise vs. individual) may have distinct pricing models, influenced by factors such as scalability and feature access. Information about the customer's geographical location can be used to set region-specific pricing, accounting for variations in cost of resources and market demand.

Contextual pricing model retriever 216 may then apply the usage to the contextual pricing model and output the credit usage. A number of tokens, such as 9000 tokens, may be retrieved from the token information attribute. Then, a usage of 9000 tokens results in a credit usage of 9000*0.001*0.95=8.55 credits. The credits that are used may be applied to a total credit pool to determine a current available number of credits. For example, 10000 credits may be in the credit pool. The organization may have used 1000 credits, so there are 9000 available credits. Then, the new available credits is 9000−8.55=8991.45 available credits. When the available credits are used and no credits remain, an action may be taken, such as generative AI solutions may be restricted and not used, a message may be sent to replenish the credit pool, etc.

Accordingly, generative AI tracking system 110 calculates the usage credits dynamically for requests based on specific contextual pricing models for different generative AI solutions 108. The dynamic approach while requests are being processed ensures that customers are accurately billed for their actual usage that uses multiple generative AI solutions 108. Also, generative AI tracking system 110 can track the usage down to the level of individual requests and responses from consumer devices. The granular tracking may provide customers with accurate records of the resources that it associated users consumed.

Generative AI solutions 108 may be managed via SKUs. The SKUs may be used in a quoting, sales, and billing system pipeline. For example, SKUs may be associated with services for different generative AI solutions 108 that are offered to customers. Then, the SKUs may be integrated into the existing cloud computing system 106 to enable the generative AI solutions 108 to be charged accurately.

### SKU Management

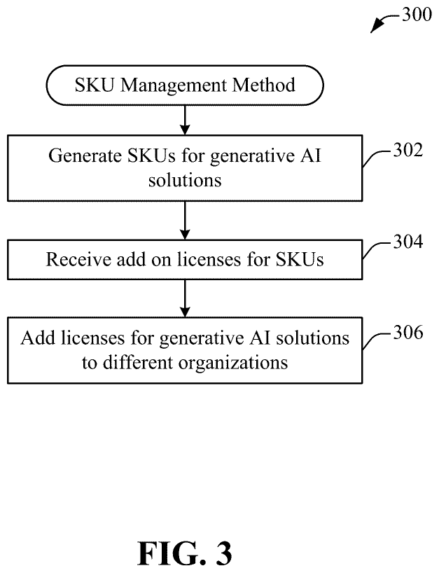

FIG. 3 depicts an example of managing SKUs according to some embodiments. The SKUs may be consumption-based SKUs that may be used in addition to other SKUs for other cloud-based services (e.g., per user-based license SKUs). The consumption-based SKUs may be integrated into a centralized billing solution that can be used with other aspects of cloud computing system 106.

At 302, SKUs for generative AI solutions 108 are generated. For example SKUs may be provided for different services that may offer the generative AI solutions.

At 304, add-on licenses for SKUs are received. Add-on licenses may add a license for generative AI solutions to existing services. For example, services such as CRM applications, may have generative AI solutions added on as add-on licenses.

At 306, the licenses are added to different organizations. For example, different organizations may have licenses for generative AI solutions 108 added.

The use of these SKUs allows a service provider to provide consumption-based services via the SKUs. Without the SKUs, it would be hard to offer the consumption-based services in addition to the user-based licenses that are offered because of the different pricing models that are used.

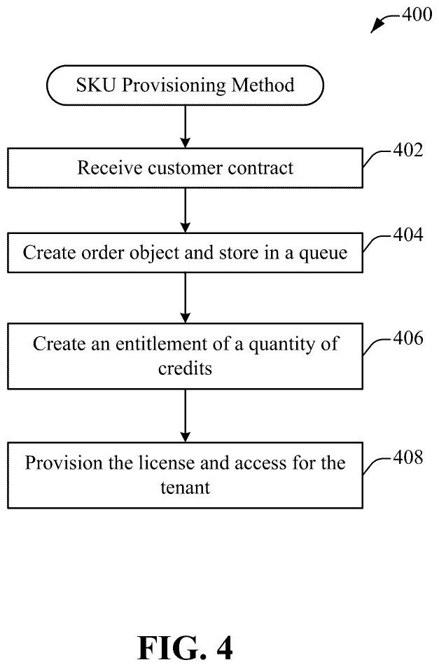

FIG. 4 depicts an example of provisioning the entitlements and licenses for the SKUs according to some embodiments. For example, the SKUs may be integrated with other SKUs that are being used for other services, such as other software applications in cloud computing system 106. At 402, a customer contract is received. The contract may be for using generative AI solutions 108 as an add on to other software applications in cloud computing system 106. At 404, generative AI tracking system 110 may create an order object and store the object in a queue. This creates the order object on a billing system and generates an action to be performed.

At 406, system 100 creates an entitlement of a quantity of credits. The quantity of credits may be added to a credit pool for a customer.

Then, at 408, system 100 provisions the license and access for the customer. For example, access to generative AI solutions 108 is provisioned using the license for a tenant. The billing of the consumption-based services may then be performed using the system in FIG. 2.

The current usage of a customer in relation to their entitlements may be tracked. This may enhance customer awareness, prevent overages, and encourage efficient resource allocation. Entitlements are the objects that are used to calculate a customer's purchase quantity of credits and track the consumption of the credits. The following may be used to track the consumption. A usage type may track the type of usage that is consumed. For example, the usage type may track the generative AI solution used, and also which product used the generative AI solution, such as generative AI may have been used to create work summaries, product decisions, etc. A usage date may be when the usage was consumed. A usage quantity may be the quantity of usage that was consumed, such as a number of credits that were consumed. A tenant ID may be the identifier for the organization that used the credits. Each transaction may be associated with the above attributes. When a customer requests a summary of the usage, the above attributes may be used to aggregate the usage and provide a summary to the customer.

### CONCLUSION

Accordingly, generative AI solutions 108 may be integrated with a service provider's quoting, sales pipeline, and billing systems. The use of generative AI solutions 108 may be consumption based and SKUs for the generative AI solutions may be generated and offered. Then, the respective contextual pricing models for generative AI solutions 108 may be retrieved and used to calculate the credit usage.

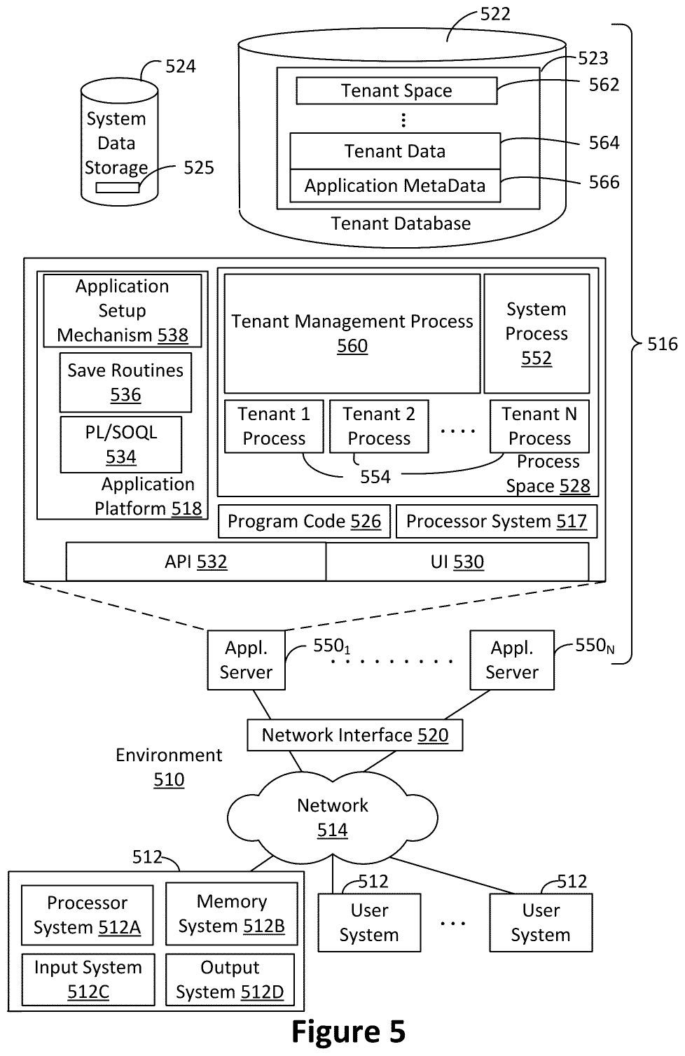

FIG. 5 shows a block diagram of an example of an environment 510 that includes an on-demand database service configured in accordance with some implementations. Environment 510 may include user systems 512, network 514, database system 516, processor system 517, application platform 518, network interface 520, tenant data storage 522, tenant data 523, system data storage 524, system data 525, program code 526, process space 528, User Interface (UI) 530, Application Program Interface (API) 532, PL/SOQL 534, save routines 536, application setup mechanism 538, application servers 550-1 through 550-N, system process space 552, tenant process spaces 554, tenant management process space 560, tenant storage space 562, user storage 564, and application metadata 566. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 516, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 518 may be a framework that allows the creation, management, and execution of applications in system 516. Such applications may be developed by the database service provider or by users or third-party application developers accessing the service. Application platform 518 includes an application setup mechanism 538 that supports application developers' creation and management of applications, which may be saved as metadata into tenant data storage 522 by save routines 536 for execution by subscribers as one or more tenant process spaces 554 managed by tenant management process 560 for example. Invocations to such applications may be coded using PL/SOQL 534 that provides a programming language style interface extension to API 532. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 566 for a subscriber making such an invocation. Such system processes may also manage execution of application metadata 566 as an application in a virtual machine.

In some implementations, each application server 550 may handle requests for any user associated with any organization. A load balancing function (e.g., an F5 Big-IP load balancer) may distribute requests to the application servers 550 based on an algorithm such as least-connections, round robin, observed response time, etc. Each application server 550 may be configured to communicate with tenant data storage 522 and the tenant data 523 therein, and system data storage 524 and the system data 525 therein to serve requests of user systems 512. The tenant data 523 may be divided into individual tenant storage spaces 562, which can be either a physical arrangement and/or a logical arrangement of data. Within each tenant storage space 562, user storage 564 and application metadata 566 may be similarly allocated for each user. For example, a copy of a user's most recently used (MRU) items might be stored to user storage 564. Similarly, a copy of MRU items for an entire tenant organization may be stored to tenant storage space 562. A UI 530 provides a user interface and an API 532 provides an application programming interface to system 516 resident processes to users and/or developers at user systems 512.

System 516 may implement a web-based generative AI system. For example, in some implementations, system 516 may include application servers configured to implement and execute generative AI software applications. The application servers may be configured to provide related data, code, forms, web pages and other information to and from user systems 512. Additionally, the application servers may be configured to store information to, and retrieve information from a database system. Such information may include related data, objects, and/or Webpage content. With a multi-tenant system, data for multiple tenants may be stored in the same physical database object in tenant data storage 522, however, tenant data may be arranged in the storage medium(s) of tenant data storage 522 so that data of one tenant is kept logically separate from that of other tenants. In such a scheme, one tenant may not access another tenant's data, unless such data is expressly shared.

Several elements in the system shown in FIG. 5 include conventional, well-known elements that are explained only briefly here. For example, user system 512 may include processor system 512A, memory system 512B, input system 512C, and output system 512D. A user system 512 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 512 to access, process and view information, pages and applications available from system 516 over network 514. Network 514 may be any network or combination of networks of devices that communicate with one another, such as any one or any combination of a LAN (local area network), WAN (wide area network), wireless network, or other appropriate configuration.

The users of user systems 512 may differ in their respective capacities, and the capacity of a particular user system 512 to access information may be determined at least in part by “permissions” of the particular user system 512. As discussed herein, permissions generally govern access to computing resources such as data objects, components, and other entities of a computing system, such as a generative AI solution, a social networking system, and/or a CRM database system. “Permission sets” generally refer to groups of permissions that may be assigned to users of such a computing environment. For instance, the assignments of users and permission sets may be stored in one or more databases of System 516. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 516 may provide on-demand database service to user systems 512 using an MTS arrangement. By way of example, one tenant organization may be a company that employs a sales force where each salesperson uses system 516 to manage their sales process. Thus, a user in such an organization may maintain contact data, leads data, customer follow-up data, performance data, goals and progress data, etc., all applicable to that user's personal sales process (e.g., in tenant data storage 522). In this arrangement, a user may manage his or her sales efforts and cycles from a variety of devices, since relevant data and applications to interact with (e.g., access, view, modify, report, transmit, calculate, etc.) such data may be maintained and accessed by any user system 512 having network access.

When implemented in an MTS arrangement, system 516 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 516 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 516 may also maintain system-level data usable by multiple tenants or other data. Such system-level data may include industry reports, news, postings, and the like that are sharable between tenant organizations.

In some implementations, user systems 512 may be client systems communicating with application servers 550 to request and update system-level and tenant-level data from system 516. By way of example, user systems 512 may send one or more queries requesting data of a database maintained in tenant data storage 522 and/or system data storage 524. An application server 550 of system 516 may automatically generate one or more SQL statements (e.g., one or more SQL queries) that are designed to access the requested data. System data storage 524 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

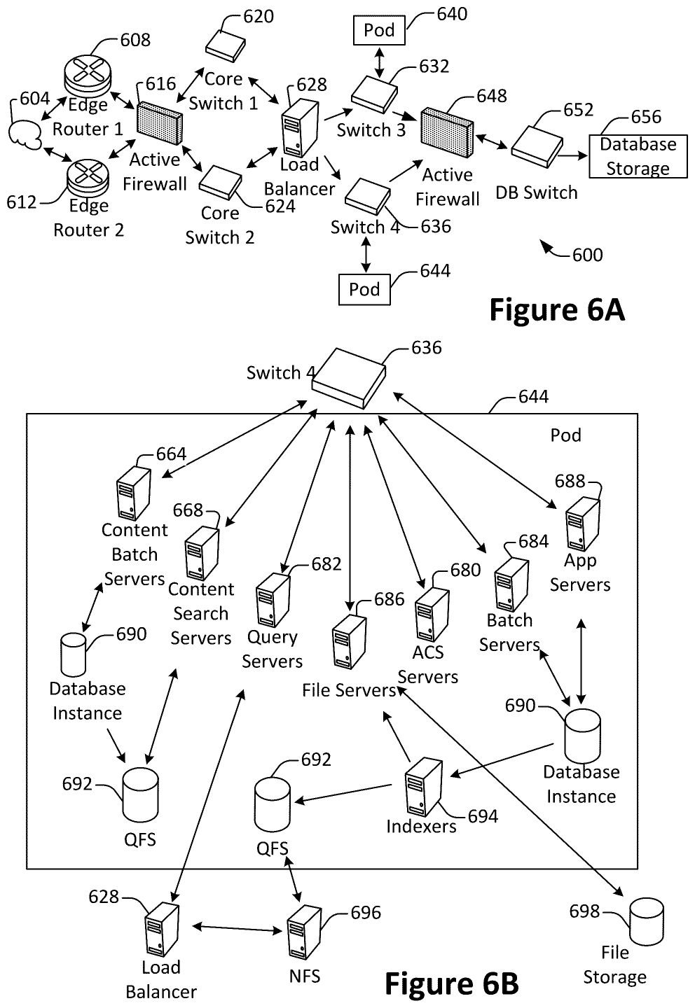

FIG. 6A shows a system diagram of an example of architectural components of an on-demand database service environment 600, configured in accordance with some implementations. A client machine located in the cloud 604 may communicate with the on-demand database service environment via one or more edge routers 608 and 612. A client machine may include any of the examples of user systems 512 described above. The edge routers 608 and 612 may communicate with one or more core switches 620 and 624 via firewall 616. The core switches may communicate with a load balancer 628, which may distribute server load over different pods, such as the pods 640 and 644 by communication via pod switches 632 and 636. The pods 640 and 644, which may each include one or more servers and/or other computing resources, may perform data processing and other operations used to provide on-demand services. Components of the environment may communicate with a database storage 656 via a database firewall 648 and a database switch 652.

Accessing an on-demand database service environment may involve communications transmitted among a variety of different components. The environment 600 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 6A and 6B.

The cloud 604 refers to any suitable data network or combination of data networks, which may include the Internet. Client machines located in the cloud 604 may communicate with the on-demand database service environment 600 to access services provided by the on-demand database service environment 600. By way of example, client machines may access the on-demand database service environment 600 to retrieve, store, edit, and/or process generative AI information.

In some implementations, the edge routers 608 and 612 route packets between the cloud 604 and other components of the on-demand database service environment 600. The edge routers 608 and 612 may employ the Border Gateway Protocol (BGP). The edge routers 608 and 612 may maintain a table of IP networks or ‘prefixes’, which designate network reachability among autonomous systems on the internet.

In one or more implementations, the firewall 616 may protect the inner components of the environment 600 from internet traffic. The firewall 616 may block, permit, or deny access to the inner components of the on-demand database service environment 600 based upon a set of rules and/or other criteria. The firewall 616 may act as one or more of a packet filter, an application gateway, a stateful filter, a proxy server, or any other type of firewall.

In some implementations, the core switches 620 and 624 may be high-capacity switches that transfer packets within the environment 600. The core switches 620 and 624 may be configured as network bridges that quickly route data between different components within the on-demand database service environment. The use of two or more core switches 620 and 624 may provide redundancy and/or reduced latency.

In some implementations, communication between the pods 640 and 644 may be conducted via the pod switches 632 and 636. The pod switches 632 and 636 may facilitate communication between the pods 640 and 644 and client machines, for example via core switches 620 and 624. Also or alternatively, the pod switches 632 and 636 may facilitate communication between the pods 640 and 644 and the database storage 656. The load balancer 628 may distribute workload between the pods, which may assist in improving the use of resources, increasing throughput, reducing response times, and/or reducing overhead. The load balancer 628 may include multilayer switches to analyze and forward traffic.

In some implementations, access to the database storage 656 may be guarded by a database firewall 648, which may act as a computer application firewall operating at the database application layer of a protocol stack. The database firewall 648 may protect the database storage 656 from application attacks such as structure query language (SQL) injection, database rootkits, and unauthorized information disclosure. The database firewall 648 may include a host using one or more forms of reverse proxy services to proxy traffic before passing it to a gateway router and/or may inspect the contents of database traffic and block certain content or database requests. The database firewall 648 may work on the SQL application level atop the TCP/IP stack, managing applications' connection to the database or SQL management interfaces as well as intercepting and enforcing packets traveling to or from a database network or application interface.

In some implementations, the database storage 656 may be an on-demand database system shared by many different organizations. The on-demand database service may employ a single-tenant approach, a multi-tenant approach, a virtualized approach, or any other type of database approach. Communication with the database storage 656 may be conducted via the database switch 652. The database storage 656 may include various software components for handling database queries. Accordingly, the database switch 652 may direct database queries transmitted by other components of the environment (e.g., the pods 640 and 644) to the correct components within the database storage 656.

FIG. 6B shows a system diagram further illustrating an example of architectural components of an on-demand database service environment, in accordance with some implementations. The pod 644 may be used to render services to user(s) of the on-demand database service environment 600. The pod 644 may include one or more content batch servers 664, content search servers 668, query servers 682, file servers 686, access control system (ACS) servers 680, batch servers 684, and app servers 688. Also, the pod 644 may include database instances 690, quick file systems (QFS) 692, and indexers 694. Some or all communication between the servers in the pod 644 may be transmitted via the switch 636.

In some implementations, the app servers 688 may include a framework dedicated to the execution of procedures (e.g., programs, routines, scripts) for supporting the construction of applications provided by the on-demand database service environment 600 via the pod 644. One or more instances of the app server 688 may be configured to execute all or a portion of the operations of the services described herein.

In some implementations, as discussed above, the pod 644 may include one or more database instances 690. A database instance 690 may be configured as an MTS in which different organizations share access to the same database, using the techniques described above. Database information may be transmitted to the indexer 694, which may provide an index of information available in the database 690 to file servers 686. The QFS 692 or other suitable filesystem may serve as a rapid-access file system for storing and accessing information available within the pod 644. The QFS 692 may support volume management capabilities, allowing many disks to be grouped together into a file system. The QFS 692 may communicate with the database instances 690, content search servers 668 and/or indexers 694 to identify, retrieve, move, and/or update data stored in the network file systems (NFS) 696 and/or other storage systems.

In some implementations, one or more query servers 682 may communicate with the NFS 696 to retrieve and/or update information stored outside of the pod 644. The NFS 696 may allow servers located in the pod 644 to access information over a network in a manner similar to how local storage is accessed. Queries from the query servers 622 may be transmitted to the NFS 696 via the load balancer 628, which may distribute resource requests over various resources available in the on-demand database service environment 600. The NFS 696 may also communicate with the QFS 692 to update the information stored on the NFS 696 and/or to provide information to the QFS 692 for use by servers located within the pod 644.

In some implementations, the content batch servers 664 may handle requests internal to the pod 644. These requests may be long-running and/or not tied to a particular customer, such as requests related to log mining, cleanup work, and maintenance tasks. The content search servers 668 may provide query and indexer functions such as functions allowing users to search through content stored in the on-demand database service environment 600. The file servers 686 may manage requests for information stored in the file storage 698, which may store information such as documents, images, basic large objects (BLOBs), etc. The query servers 682 may be used to retrieve information from one or more file systems. For example, the query system 682 may receive requests for information from the app servers 688 and then transmit information queries to the NFS 696 located outside the pod 644. The ACS servers 680 may control access to data, hardware resources, or software resources called upon to render services provided by the pod 644. The batch servers 684 may process batch jobs, which are used to run tasks at specified times. Thus, the batch servers 684 may transmit instructions to other servers, such as the app servers 688, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

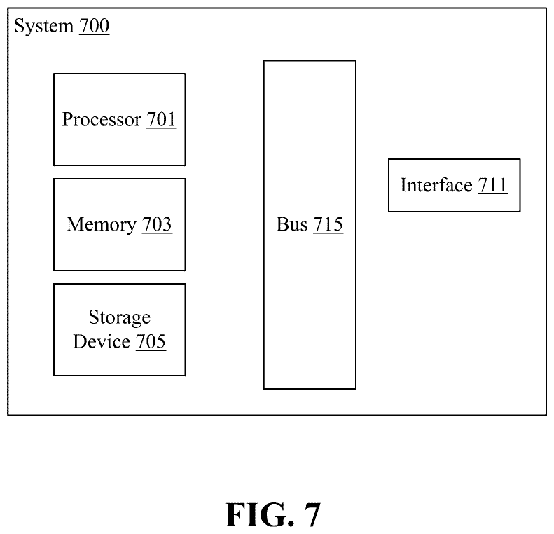

FIG. 7 illustrates one example of a computing device. According to various embodiments, a system 700 suitable for implementing embodiments described herein includes a processor 701, a memory module 703, a storage device 705, an interface 711, and a bus 715 (e.g., a PCI bus or other interconnection fabric.) System 700 may operate as variety of devices such as an application server, a database server, or any other device or service described herein. Although a particular configuration is described, a variety of alternative configurations are possible. The processor 701 may perform operations such as those described herein. Instructions for performing such operations may be embodied in the memory 703, on one or more non-transitory computer readable media, or on some other storage device. Various specially configured devices can also be used in place of or in addition to the processor 701. The interface 711 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques of disclosed herein apply to a wide variety of computing environments. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A method comprising:
storing a total number of generative credits for a generative artificial intelligence (AI) solution that is integrated with a software application in a database system;
tracking usage data of a request to the generative artificial intelligence (AI) solution in the database system;
determining a context from the usage data;
retrieving a contextual pricing model for the generative AI solution using the context, wherein the contextual pricing model translates a model specific charging policy to generative credits;
applying the usage data to the contextual pricing model to translate the usage data to a number of generative credits; and
applying the number of generative credits for the generative AI solution to an available number of generative credits of the total number of generative credits to generate a new available number of generative credits.

2. The method of claim 1, wherein tracking the usage comprises:
receiving the request for the generative AI solution; and
tracking information for the request in the usage data based on a set of attributes.

3. The method of claim 2, wherein an attribute in the set of attributes is used to determine the context.

4. The method of claim 2, wherein an attribute in the set of attributes is used to determine the number of generative credits.

5. The method of claim 1, wherein determining the context comprises:
determining an identifier for the generative AI solution from a plurality of generative AI solutions based on the usage data, wherein the identifier is used to retrieve the contextual pricing model.

6. The method of claim 1, wherein determining the context comprises:
determining an identifier for an organization from a plurality of organizations that are using the database system based on the usage data, wherein the identifier is used to retrieve the contextual pricing model.

7. The method of claim 1, wherein retrieving the contextual pricing model comprises:
selecting the contextual pricing model from a plurality of contextual pricing models based on a set of dimension values from the context.

8. The method of claim 7, wherein the contextual pricing model is selected based on an identifier for the generative AI solution.

9. The method of claim 7, wherein the contextual pricing model is selected based on an identifier for an organization that sent the request.

10. The method of claim 1, wherein applying the usage data to the contextual pricing model to translate the usage to the number of generative credits comprises:
determining a number of tokens in the usage data; and
applying the number of tokens to the contextual pricing model to generate the number of generative credits.

11. The method of claim 10, wherein the number of tokens are determined from a number of words in the request for the generative AI solution.

12. The method of claim 1, further comprising:
receiving an order for the total number of generative credits; and
creating an entitlement for the total number of generative credits, wherein the total number of generative credits is usable for accessing the generative AI solution.

13. The method of claim 12, further comprising:
provisioning a license for access to the generative AI solution using the total number of generative credits.

14. The method of claim 1, further comprising:
generating a SKU for the generative AI solution; and
adding a license to use the generative AI solution based on the total number of generative credits.

15. The method of claim 14, further comprising:
adding a license to use another service other than the generative AI solution, wherein the other service is charged based on a per-user license.

16. A non-transitory computer-readable storage medium having stored thereon computer executable instructions, which when executed by a computing device, cause the computing device to be configurable to cause:
storing a total number of generative credits for a generative artificial intelligence (AI) solution that is integrated with a software application in a database system;
tracking usage data of a request to the generative artificial intelligence (AI) solution in the database system;
determining a context from the usage data;
retrieving a contextual pricing model for the generative AI solution using the context, wherein the contextual pricing model translates a model specific charging policy to generative credits;
applying the usage data to the contextual pricing model to translate the usage data to a number of generative credits; and
applying the number of generative credits for the generative AI solution to an available number of generative credits of the total number of generative credits to generate a new available number of generative credits.

17. The non-transitory computer-readable storage medium of claim 16, wherein applying the usage data to the contextual pricing model to translate the usage to the number of generative credits comprises:
determining a number of tokens in the usage data; and
applying the number of tokens to the contextual pricing model to generate the number of generative credits.

18. The non-transitory computer-readable storage medium of claim 16, wherein retrieving the contextual pricing model comprises:
selecting the contextual pricing model from a plurality of contextual pricing models based on a set of dimension values from the context.

19. The non-transitory computer-readable storage medium of claim 16, receiving an order for the total number of generative credits; and
creating an entitlement for the total number of generative credits, wherein the total number of generative credits is usable for accessing the generative AI solution.

20. An apparatus comprising:
one or more computer processors; and
a computer-readable storage medium comprising instructions for controlling the one or more computer processors to be configurable to cause:
storing a total number of generative credits for a generative artificial intelligence (AI) solution that is integrated with a software application in a database system;
tracking usage data of a request to the generative artificial intelligence (AI) solution in the database system;
determining a context from the usage data;
retrieving a contextual pricing model for the generative AI solution using the context, wherein the contextual pricing model translates a model specific charging policy to generative credits;
applying the usage data to the contextual pricing model to translate the usage data to a number of generative credits; and
applying the number of generative credits for the generative AI solution to an available number of generative credits of the total number of generative credits to generate a new available number of generative credits.
